(19) United States
(12) Patent Application Publication
(10) Pub. No.: US 2025/0287103 A1
(43) Pub. Date: Sep. 11, 2025

(54) SPIN-OUT 360-DEGREE CAMERA FOR SMARTPHONE

(71) Applicant: Corephotonics Ltd., Tel Aviv (IL)

(72) Inventor: Gal Adler, Tel Aviv (IL)

(21) Appl. No.: 19/218,279

(22) Filed: May 25, 2025

Related U.S. Application Data
(63) Continuation of application No. 18/194,637, filed on Apr. 2, 2023, now Pat. No. 12,348,870.
(60) Provisional application No. 63/329,384, filed on Apr. 9, 2022.

(51) Int. Cl. H04N 23/69; H04N 23/50; H04N 23/54; H04N 23/57

(52) U.S. Cl. CPC H04N 23/69; H04N 23/50; H04N 23/54; H04N 23/57

(57) ABSTRACT

Camera modules comprising two sub-cameras included in a camera housing and a spin-out actuator. The two sub-cameras are a first sub-camera with first field of view (FOV) FOV1≥180 deg oriented along a camera module optical axis and pointing in a first direction and a second sub-camera having a second FOV, FOV2≥180 deg, the second sub-camera being oriented along the camera module optical axis and pointing in a second direction which is opposite to the first direction. Such a camera module is operational to capture a 360 degree panoramic image or video stream by combining images obtained with the first sub-camera and the second sub-camera, where the spin-out actuator is operational to rotate the camera housing around an axis perpendicular to the camera module optical axis for switching the camera between a stowed position and a spun-out/operational position.

### CROSS REFERENCE TO RELATED APPLICATIONS

This application is a continuation application of U.S. patent application Ser. No. 18/194,637 filed Apr. 2, 2023 (now allowed), which claims the benefit of priority from U.S. provisional patent application No. 63/329,384 filed Apr. 9, 2022, which is incorporated herein by reference in its entirety.

### FIELD

The subject matter disclosed herein relates in general to cameras embedded in mobile devices, in particular cameras embedded in smartphones.

### BACKGROUND

Mobile electronic handheld devices (“mobile devices”) such as smartphones or tablets having multiple cameras (or “multi-cameras”) with different fields of view (FOVs) are ubiquitous. In the following, we use “mobile device” and “smartphone” interchangeably.

A well-known camera type in the photography field is the omnidirectional camera (“omni” meaning “all”), also known as “360-degree camera” or 360° camera. This is a camera having a FOV that covers an entire 360° sphere. Omnidirectional cameras are important and prevalent in areas where large visual field coverage is needed, such as in panoramic photography as well as in action and sport videography. For example, a 360° camera can be realized by using two sub-cameras, where (i) each of the sub-cameras covers a FOV of 180 degrees or more (“180-degree sub-camera”) and (ii) the FOVs of the sub-cameras cover different segments of a scene. By combining (or “stitching”) simultaneously captured images from the two sub-cameras, the entire 360° sphere is covered.

In recent years, there have been attempts to embed a 360° camera in mobile devices. However, the physical (or size) constraints of such cameras have hindered those attempts. In particular, the 180-degree sub-cameras must protrude from the mobile device's housing to be able to cover a FOV of 180 degrees or more. In general, a mobile device's industrial design is optimized for a low thickness and plane surfaces. The need for protrusion of a 360° camera conflicts with the aforementioned requirement for low thickness and plane surfaces and represents a technical challenge.

It would be advantageous to have a spin-out 360° camera integrated in a mobile device that is switchable between a “stowed” state—in which the camera module is inactive, and a “spun-out” state—in which the camera module is active and operational to capture the entire 360° sphere. The spin-out 360° camera protrudes only when the camera is in use (spun-out) and does not protrude when the camera is not in use (stowed). It is observed that the slimness and flatness are required only when the camera is inactive, e.g. when a mobile device is in a pocket or similar enclosed space. Thus, making the camera module spin-out and stow on request bridges the conflicting requirements.

### SUMMARY

In various exemplary embodiments, there are provided camera modules, comprising: a first sub-camera comprising a first lens having a first effective focal length (EFL₁) and a first image sensor, the first sub-camera having a first field of view FOV1≥180 degrees and being oriented along a camera module optical axis and pointing in a first direction; a second sub-camera comprising a second lens having a second effective focal length (EFL₂)=EFL₁ and a second image sensor, the second sub-camera having a second field of view FOV2≥180 degrees and being oriented along the camera module optical axis and pointing in a second direction which is opposite to the first direction; and a spin-out actuator, wherein the first sub-camera and the second sub-camera are included in a camera housing, wherein the camera is operational to capture a 360 degree panoramic image or video stream by combining images obtained with the first sub-camera and with the second sub-camera, wherein the spin-out actuator is operational to rotate the camera housing around an axis perpendicular to the camera module optical axis for switching the camera between a stowed position and a spun-out position, wherein the camera module is active in the spun-out position.

In some examples, the camera module is included in a mobile device, wherein in the spun-out operational position the camera module optical axis is perpendicular to a front surface of the mobile device.

In some examples, the camera module is included in a mobile device, wherein in the stowed position the camera module optical axis is parallel to a front surface of the mobile device.

In some examples, the camera module is included in a mobile device, wherein in the stowed position the camera module housing is flush with both a front surface and a rear surface of the mobile device.

In some examples, the camera housing is rotated by 90 degrees for switching between the stowed position and the spun-out position.

In some examples, the camera module is included in a mobile device, the first image sensor and the second image sensor are mounted on a single printed circuit board.

In some examples, the camera module has a camera module height HM in the range of 5 mm-20 mm. In some examples, HM is in the range of 7 mm-11 mm.

In some examples, the camera module has a camera module width WM in the range of 10 mm-30 mm. In some examples, WM is in the range of 15 mm-20 mm.

In some examples, the spin-out actuator is an actuator selected from the group consisting of an electric stepper motor, a voice coil motor, and a shaped memory alloy actuator.

In some examples, the camera module comprises a spin-out mechanism to rotate the camera housing, wherein the spin-out mechanism includes a worm-screw and a worm wheel, and wherein the worm-screw engages with the worm wheel.

In some examples, EFL₁ and EFL₂ are in the range of 0.75 mm-2.5 mm. In some examples, EFL₁ and EFL₂ are in the range of 0.9 mm-1.5 mm. In some examples, EFL₁ and EFL₂ are in the range of 0.75 mm-2.5 mm EFL₁ and EFL₂ are in the range of 1 mm-1.2 mm.

In some examples, the first lens and the second lens each include N=6 lens elements. In some examples, a power sequence of the N=6 lens elements is negative-negative-positive-positive-negative-positive.

In some examples, a first lens element L₁ of both the first lens and the second lens is made of glass. In some examples, a last lens element L₆ of both the first lens and the second lens is the strongest lens element in the lens. In some examples, a last lens element L₆ of both the first lens and the second lens is the strongest lens element in the lens.

In some examples, a f number f₃ of a third lens element L₃ of both the first lens and the second lens fulfills f₃<2×EFL. In some examples, both the first lens and the second lens have a f number lower than 3.

In some examples, both FOV1 and FOV2 are smaller than 200 degrees.

In some examples, a camera module is included in a mobile device such as a smartphone.

In some examples, a camera module is included in a multi-camera. In some examples, the multi-camera is included in a mobile device such as a smartphone.

### BRIEF DESCRIPTION OF THE DRAWINGS

Non-limiting examples are described below with reference to figures attached hereto that are listed following this paragraph. Identical structures, elements or parts that appear in more than one figure are generally labelled with a same numeral in all the figures in which they appear. The drawings and descriptions are meant to illuminate and clarify examples of the subject matter disclosed herein, and should not be considered limiting in any way. In the drawings:

FIG. 1A illustrates a smartphone including a 360° camera disclosed herein in a stowed state in a front view;

FIG. 1B illustrates the smartphone and 360° camera of FIG. 1A in a spun-out state in a front view;

FIG. 2A illustrates the smartphone and 360° camera of FIGS. 1A-B in a stowed state in one side view;

FIG. 2B illustrates the smartphone and 360° camera of FIGS. 1A-B in a spun-out state in one side view;

FIG. 3A illustrates the smartphone and 360° camera of FIGS. 1A-B in a stowed state in another side view;

FIG. 3B illustrates the smartphone and 360° camera of FIGS. 1A-B in a spun-out state in another side view;

FIG. 4 illustrates another embodiment of a 360° camera disclosed herein;

FIG. 5 shows an example of an optical lens system for use in a 360° camera disclosed herein.

### DETAILED DESCRIPTION

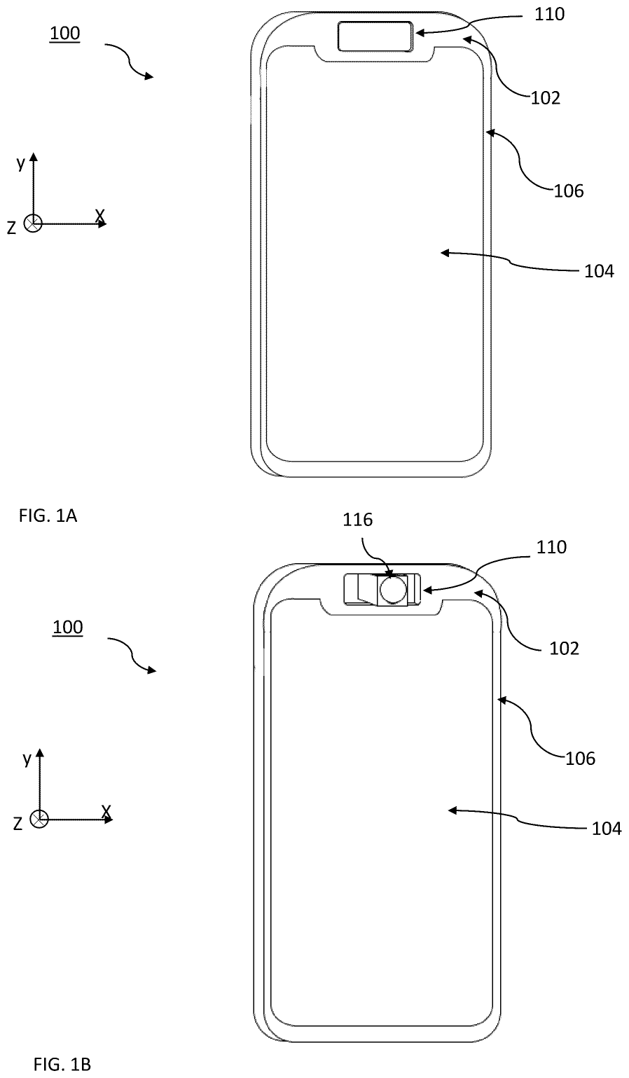

FIG. 1A illustrates a smartphone 100 including a 360-degree camera 110 as disclosed herein in a “stowed” state in a front view. Hereinafter, 360° cameras described below may drop the “360°” term for simplicity. In the stowed state, camera 110 is inactive. Smartphone 100 includes a first area 102 which does not include a screen (“bezel area”), a second area 104 which includes a screen (“screen area”), and a housing (body) 106.

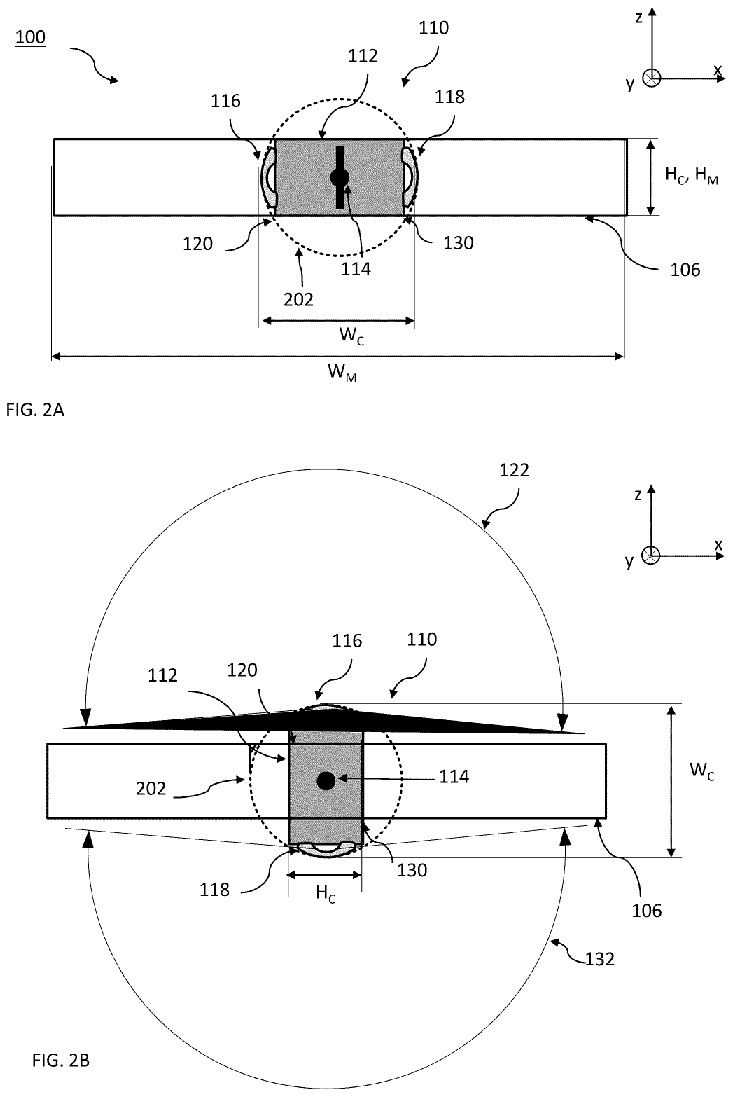

A front surface (or “user surface”) of smartphone 100 is visible. “Front surface” of a smartphone is defined here as the surface of the smartphone that includes a screen. Accordingly, a “rear surface” (or “world facing surface”) of a smartphone is defined here as a surface parallel to the front surface, but having a surface normal that points in an opposite direction than a surface normal of the front surface. In general, the rear surface does not include a screen. Camera 110 is included (i.e. embedded) in bezel area 102. Camera 110 includes two, first and second sub-cameras (not shown here), see 120 and 130 in FIGS. 2A-B. Optical axes of the first sub-camera and of the second sub-camera of camera 110 (not shown) are oriented parallel to the x-axis in the x-y-z coordinate system shown. In the stowed state, camera 110 is positioned so that it forms a plane surface (i.e. “is flush”) with the surrounding bezel area 102. In the stowed state, an aperture of the first sub-camera and an aperture of the second sub-camera are not exposed and are therefore protected from damage in case of a drop or an impact.

FIG. 1B illustrates smartphone 100 including camera 110 in a “spun-out” state in the same view shown in FIG. 1A. In the spun-out state, camera 110 is active. A first aperture 116 of camera 110 is visible. The optical axes of the first sub-camera and of the second sub-camera of camera 110 are now oriented parallel to the z-axis. With respect to the stowed state in FIG. 1A, camera 110 is rotated by 90 degrees around the y-axis. In this (active) spun-out state, camera 110 has an unobstructed FOV of more than 180 degrees, i.e. the FOV of lenses of camera 110 is not obstructed by housing 106 or any other component included in smartphone 100. In other embodiments for switching a camera such as camera 110 from a stowed state to a spun-out state, the camera may be rotated by 90 degrees around the x-axis.

In some examples, camera 110 may be included in a multi-camera as known in the art. In a multi-camera, two or more cameras are included that have lenses with different focal lengths to capture images of a same scene with FOVs. For example, in addition to camera 110, a multi-camera may include a Wide camera having a Wide camera FOV (“FOV_{W}”) of e.g. 80 degrees and a Tele (or “zoom”) camera having a narrower FOV (“native FOV_{T}” or (“n-FOV_{T}”)) of e.g. 25 degrees and with higher spatial resolution (for example 3-5 times higher) than that of the Wide camera. Smartphone 100 may in addition include an application processor (“AP”), e.g. configured to switch between different cameras in the multi-camera, to process image data of the multi-camera, to supply control signals for switching camera 110 from a stowed state to a spun-out state and vice versa etc.

FIG. 2A illustrates smartphone 100 including 360° camera 110 of FIGS. 1A-B in a stowed state in a cross-sectional view. Smartphone 100 has a smartphone module height HM and a smartphone module width WM. Camera 110 includes a housing 112 and a pivot (or “rotation”) axis 114. For switching camera 110 between a stowed (inactive) and a spun-out (operational) state, camera 110 is rotated by 90 degrees around pivot axis 114. Pivot axis 114 is substantially parallel to the y-axis. A first aperture 116 of first sub-camera 120 and a second aperture 118 of second sub-camera 130 of camera 110 are visible. In the inactive state, both first aperture 116 and second aperture 118 are directed towards the inwards of smartphone 100, i.e. camera 110 cannot capture a scene. Camera 110 has a camera width of W_{C} (measured along the y-axis) and a camera height H_{C} (measured along the z-axis). In some examples, WM may be 10 mm-30 mm and HM may be 5 mm-20 mm. In some examples, WM may be 15-20 mm and HM may be 7-11 mm. In some examples, WM may be 18 mm and HM may be 9 mm. A circle 202 is defined as the smallest circle that fully encircles (or contains) camera 110.

FIG. 2B illustrates smartphone 100 including camera 110 in a spun-out state in a cross-sectional view. Both first aperture 116 and second aperture 118 are directed towards a scene, and both first sub-camera 120 and second sub-camera 130 are operational to capture the scene. A first FOV 122 of first sub-camera 120 and a second FOV 132 of second sub-camera 130 may have identical sizes (values), or may be different. First FOV 122 and second FOV 132 may each cover about 150-210 degrees, or preferably they may cover 180-210 degrees.

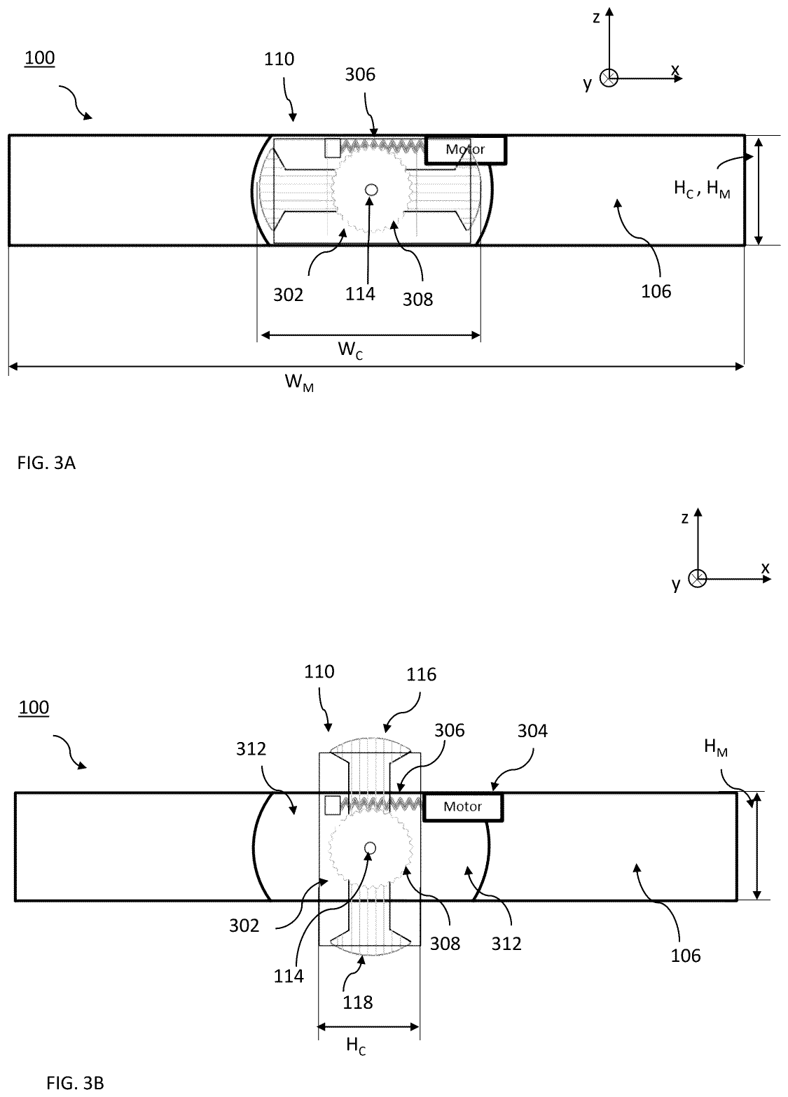

FIG. 3A and FIG. 3B illustrate smartphone 100 including camera 110 in another cross-sectional view in, respectively, stowed and spun-out states. Camera 110 includes a spin-out mechanism 302 operational to rotate camera 110 around pivot axis 114 for switching camera 110 between the stowed and spun-out states. Spin-out mechanism 302 includes an actuator 304 that is connected to a worm screw 306. Worm screw 306 engages with a worm wheel 308 to transmit the actuation of actuator 304 so that camera 110 is rotated around the y-axis at pivot 114. Actuator 304 may for example be an electric stepper motor, a voice coil motor (VCM), or a shaped memory alloy (SMA) actuator. In the spun-out state, a free space (or volume) 312 is generated.

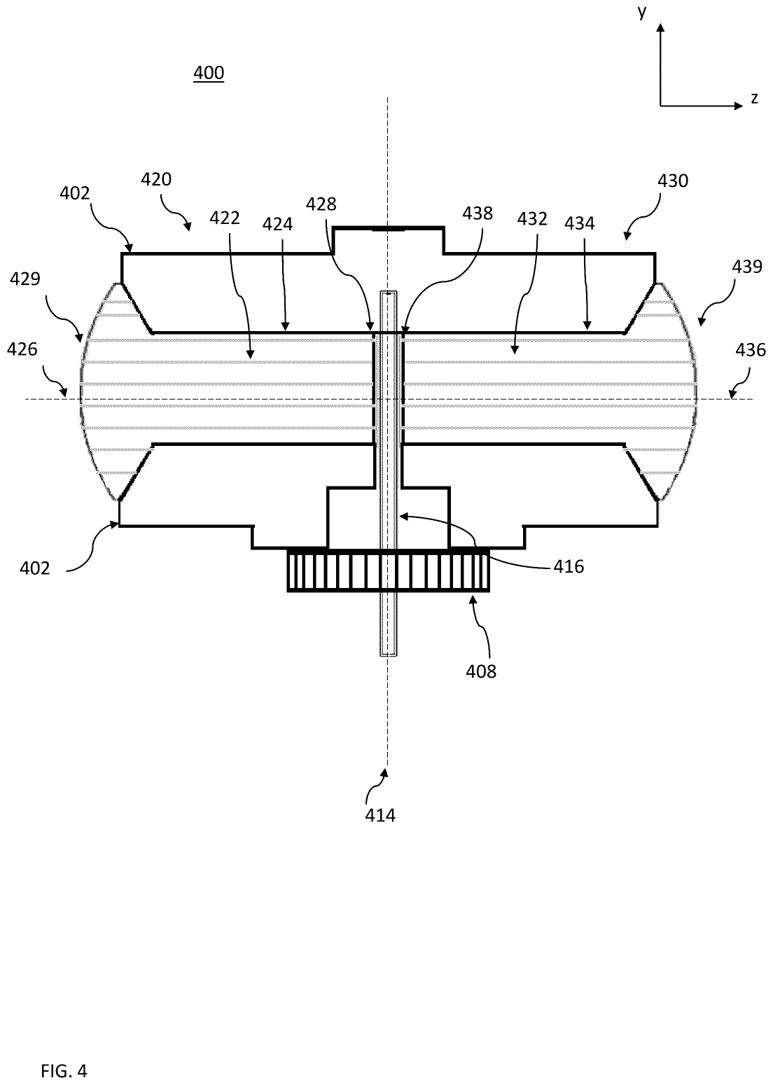

FIG. 4 illustrates another example of a 360-degree camera disclosed herein and numbered 400. Camera 400 includes a first sub-camera 420, a second sub-camera 430, and a camera module housing 402. First sub-camera 420 and second sub-camera 430 include respectively lenses 422 and 432 included in lens barrels 424 and 434 and having lens optical axes 426 and 436, image sensors 428 and 438, and apertures 429 and 439. Image sensor 428 and image sensor 438 are oriented parallel to each other and perpendicular to optical axes 426 and 436, wherein the active regions (i.e. the regions including imaging pixels) of image sensor 428 and image sensor 438 face opposite directions. Image sensor 428 points towards (or faces) a negative z-direction, and image sensor 438 points towards (or faces) a positive z-direction. A pivot (rotation) axis 414 is substantially parallel to the y-axis. Image sensor 428 and image sensor 438 may both be mounted on a single printed circuit board (PCB) 416. In other examples, two or more PCBs may be used to mount two image sensors such as image sensor 428 and image sensor 438. To supply control signals and retrieve image data from camera 400, PCB 416 or the two or more PCBs may be electrically connected to a smartphone including camera 400 by a flexible electric cable (not shown). A worm wheel 408 may transmit the actuation required for switching camera 400 between a stowed state and a spun-out state.

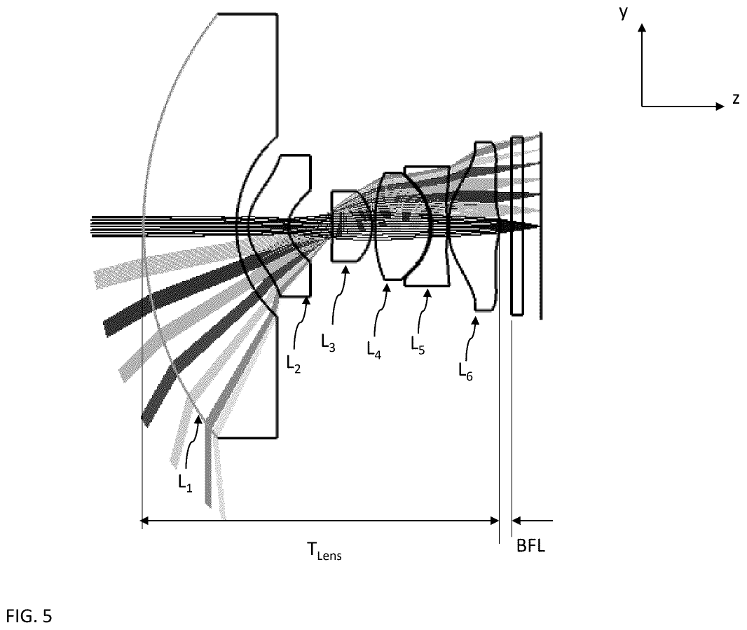

FIG. 5 shows an example of an optical lens system disclosed herein and numbered 500. Optical lens system 500 comprises a lens 502, an image sensor 504 and, optionally, an optical element (“window”) 506. Optical element 506 may be for example infra-red (IR) filter, and/or a glass image sensor dust cover. Optical lens system 500 may be used in a sub-camera of a 360-degree camera such as first sub-camera 420 and second sub-camera 430.

Optical rays pass through lens 502 and form an image on image sensor 504.

Detailed optical data and surface data for lens 502 are given in Tables 1-2. Optical lens system 500 has a FOV of 191 degrees, an EFL of 1.08 mm and a f number of 2.72.

Table 1 provides surface types and Table 2 provides aspheric coefficients.
The surface types are:
a) Plano: flat surfaces, no curvature
b) Q type 1 (QT1) surface sag formula:

$$z ( r ) = \frac{{cr}^{2}}{1 + \sqrt{1 - ( 1 + k ) {c}^{2} {r}^{2}}} + {D}_{con} ( u ) \qquad ( Eq . 1 )$$

$${D}_{con} ( u ) = {u}^{4} {\sum }_{n = 0}^{N} {A}_{n} {Q}_{n}^{con} ( {u}^{2} )$$

$$u = \frac{r}{{r}_{norm}} , x = {u}^{2}$$

$${Q}_{0}^{con} ( x ) = 1 {Q}_{1}^{con} = - ( 5 - 6 x ) {Q}_{2}^{con} = 15 - 14 x ( 3 - 2 x )$$

$${Q}_{3}^{con} = - \{ 35 - 12 x [ 14 - x ( 21 - 10 x ) ] \}$$

$${Q}_{4}^{con} = 70 - 3 x \{ 168 - 5 x [ 84 - 11 x ( 8 - 3 x ) ] \}$$

$${Q}_{5}^{con} = - [ 126 - x ( 1260 - 11 x \{ 420 - x [ 720 - 13 x ( 45 - 14 x ) ] \} ) ]$$

c) Even Asphere (ASP) surface sag formula:

$$z ( r ) = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad ( Eq . 2 )$$

where {z, r} are the standard cylindrical polar coordinates, c is the paraxial curvature of the surface, k is the conic parameter, rₙₒᵣₘ is generally one half of the surface's clear aperture (“CA”, or also “DA” for clear aperture diameter), and Aₙ are the aspheric coefficients shown in lens data tables.

The Z axis is positive towards image. Values for CA are given as a clear aperture radius, i.e. D/2. The reference wavelength is 555.0 nm. Units in Table 1 are in mm except for refraction index (“Index”) and Abbe #. Each lens element Li has a respective focal length fᵢ, both given in Table 1.

TABLE 1
Optical lens system 500
EFL = 1.08 mm, F# = 2.72, FOV = 191 deg.

| | | | Curvature | | Aperture | | | | Focal |
|---|---|---|---|---|---|---|---|---|---|
| Surface # | Comment | Type | Radius | Thickness | Radius (D/2) | Material | Index | Abbe # | Length |
| 1 | Lens 1 | Standard | 6.529 | 1.784 | 4.068 | Glass | 1.95 | 32.3 | −4.679 |
| 2 | | | 2.303 | 0.222 | 1.725 | | | | |
| 3 | Lens 2 | QT1 | 0.824 | 0.763 | 1.358 | Plastic | 1.58 | 28.4 | −5.858 |
| 4 | | | 0.436 | 0.783 | 0.697 | | | | |
| 5 | A.S. | Plano | Infinity | 0.071 | 0.219 | | | | |
| 6 | Lens 3 | QT1 | −43.758 | 0.759 | 0.333 | Plastic | 1.53 | 55.7 | 1.607 |
| 7 | | | −0.8509 | 0.058 | 0.675 | | | | |
| 8 | Lens 4 | QT1 | 12.013 | 1.052 | 0.986 | Plastic | 1.53 | 55.7 | 2.741 |
| 9 | | | −1.624 | 0.041 | 1.024 | | | | |
| 10 | Lens 5 | QT1 | −1.956 | 0.294 | 1.009 | Plastic | 1.67 | 19.2 | −2.384 |
| 11 | | | 9.781 | 0.033 | 1.147 | | | | |
| 12 | Lens 6 | QT1 | 3.686 | 0.969 | 1.495 | Plastic | 1.54 | 55.9 | 1.345 |
| 13 | | | −0.832 | 0.232 | 1.617 | | | | |
| 14 | Filter | Plano | Infinity | 0.210 | — | Glass | 1.52 | 64.2 | |
| 15 | | | Infinity | 0.350 | — | | | | |
| 16 | Image | Plano | Infinity | — | — | | | | |

TABLE 2

| | | Aspheric Coefficients | | | | |
|---|---|---|---|---|---|---|
| Surface # | Norm Radius | Conic | A0 | A1 | A2 | A3 |
| 3 | 1.352 | −2.324 | −0.04791 | −0.05523 | 0.015938 | −0.00196 |
| 4 | 0.679 | −0.645 | −0.318956 | −0.019675 | −0.010019 | −0.001377429 |
| 5 (SA) | 0 | 0 | 0 | 0 | 0 | 0 |
| 6 | 0.544 | −1.662 | 0.022799 | 0.028698 | 0.010205 | −1.46082E−05 |
| 7 | 0.813 | −0.098 | 0.07629 | −0.007024 | 0.00877 | −0.007080169 |
| 8 | 1.304 | 124.913 | 0.176348 | −0.125627 | −0.006741 | −0.009985724 |
| 9 | 1.140 | 0.232 | −0.217642 | 0.109874 | −0.000286 | 0.001776936 |
| 10 | 1.431 | −0.240 | −0.193425 | 0.330347 | −0.11511 | −0.022503981 |
| 11 | 1.337 | 65.327 | −0.075806 | 0.035603 | −0.014417 | 0.005430028 |
| 12 | 1.362 | 3.497 | 0.304975 | −0.17175 | 0.057573 | −0.02251768 |
| 13 | 2.045 | −2.236 | 1.275921 | −0.720937 | 0.221204 | −0.21164209 |

| | Aspheric Coefficients (Continued) | | | | |
|---|---|---|---|---|---|
| Surface # | A4 | A5 | A6 | A7 | A8 |
| 3 | 3.92449E−05 | −0.00028 | −3.4466E−05 | 7.11888E−05 | −0.00011 |
| 4 | −0.001139 | −0.00034385 | −0.00011 | −5.09204E−06 | 3.11037E−06 |
| 5 (SA) | 0 | 0 | 0 | 0 | 0 |
| 6 | −0.007396 | −0.0105359 | −0.007271 | −0.002404784 | −9.43331E−05 |
| 7 | −0.001707 | 0.000908346 | 0.002366 | −0.000553186 | −0.00223188 |
| 8 | 0.01722 | 0.00132032 | −0.002979 | −0.006638898 | −0.002825671 |
| 9 | −0.005606 | −0.00098302 | −0.001488 | 0.001349993 | 0.002046746 |
| 10 | −0.019598 | 0.023306945 | −0.006583 | 0.012424048 | −0.009745867 |
| 11 | −0.029477 | 0.012113887 | −0.008651 | 0.007679978 | 0.003367427 |
| 12 | 0.006928 | −0.00083061 | −0.00035 | 0.00076921 | −0.000764853 |
| 13 | −0.03595 | −0.05541839 | 0.088623 | 0.08797425 | 0.064227559 |

Optical lens system 500 has an effective focal length (“EFL”) of 1.08 mm. A power sequence of lenses L₁-L₆ included in lens 502 is negative-negative-positive-positive-negative-positive. L₁ is made of glass. A focal length of lens element Lᵢ is fᵢ, i=1-6. f₃<2·EFL and f₆<2·EFL or even f₆<1.5·EFL. L₂ is the lens element having a largest focal length magnitude, i.e. |f₂|>|fᵢ|, i=1, 3, . . . . In other embodiments, EFL may be in the range of 0.5 mm-5 mm, or even in the range 0.75 mm-2.5 mm, for example 0.9 mm-1.5 mm or 1 mm-1.2 mm.

For the sake of clarity, the term “substantially” is used herein to imply the possibility of variations in values within an acceptable range. According to one example, the term “substantially” used herein should be interpreted to imply possible variation of 0-10% over or under any specified value.

It is to be noted that the various features described in the various embodiments can be combined according to all possible technical combinations.

It is to be understood that the disclosure is not limited in its application to the details set forth in the description contained herein or illustrated in the drawings. The disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the disclosure as hereinbefore described without departing from its scope, defined in and by the appended claims.

1. A mobile device, comprising:
a screen; and
a camera module, comprising:
a first sub-camera having a first lens, a first effective focal length (EFL₁), a first image sensor and a first field of view (FOV1)≥180 degrees, the first sub-camera pointing in a first direction,
a second sub-camera having a second lens, a second effective focal length (EFL₂)=EFL₁, a second image sensor and a second field of view (FOV2)≥180 degrees, the second sub-camera pointing in a second direction which is opposite to the first direction, and
a spin-out actuator,
wherein the first sub-camera and the second sub-camera are included in a camera housing,
wherein the camera module is operational to capture a 360 degree panoramic image or video stream by combining images obtained with the first sub-camera and with the second sub-camera,
wherein the spin-out actuator is operational to rotate the camera housing for switching the camera between a stowed position and a spun-out position,
wherein the camera module is active in the spun-out position,
wherein in the spun-out position the first and second directions are perpendicular to the screen.

2. The mobile device of claim 1, wherein EFL₁ and EFL₂ are in the range of 0.75 mm-2.5 mm.

3. The mobile device of claim 1, wherein in the stowed position the first and second directions are parallel to the screen.

4. The mobile device of claim 1, wherein in the stowed position the camera housing is flush with both a front surface and a rear surface of the mobile device.

5. The mobile device of claim 1, wherein the camera module has a camera module height HM in the range of 5 mm-20 mm.

6. The mobile device of claim 5, wherein HM is in the range of 7 mm-11 mm.

7. The mobile device of claim 1, wherein the camera module has a camera module width WM in the range of 10 mm-30 mm.

8. The mobile device of claim 7, wherein WM is in the range of 15 mm-20 mm.

9. The mobile device of claim 1, wherein the spin-out actuator is an actuator selected from the group consisting of an electric stepper motor, a voice coil motor, and a shaped memory alloy actuator.

10. The mobile device of claim 1, wherein the camera module comprises a spin-out mechanism to rotate the camera housing, wherein the spin-out mechanism includes a worm-screw and a worm wheel, and wherein the worm-screw engages with the worm wheel.

11. The mobile device of claim 1, wherein EFL₁ and EFL₂ are in the range of 0.9 mm-1.5 mm.

12. The mobile device of claim 1, wherein EFL₁ and EFL₂ are in the range of 1 mm-1.2 mm.

13. The mobile device of claim 1, wherein each of the first lens and the second lens include N=6 lens elements.

14. The mobile device of claim 13, wherein a power sequence of the N=6 lens elements is negative-negative-positive-positive-negative-positive.

15. The mobile device of claim 1, wherein a first lens element Lᵢ of both the first lens and the second lens is made of glass.

16. The mobile device of claim 1, wherein a last lens element L₆ of both the first lens and the second lens is the strongest lens element in the lens.

17. The mobile device of claim 1, wherein an f number f₃ of a third lens element L₃ of both the first lens and the second lens fulfills f₃<2×EFL.

18. The mobile device of claim 1, wherein both the first lens and the second lens have a f number lower than 3.

19. The mobile device of claim 1, wherein both FOV1 and FOV2 are smaller than 200 degrees.

20. The mobile device of claim 1, wherein the mobile device is a smartphone.
